(19) United States
(12) Patent Application Publication
(10) Pub. No.: US 2026/0328134 A1
(43) Pub. Date: Oct. 22, 2026

(54) VEHICLE CONTROLLER AND VEHICLE CONTROL METHOD

(71) Applicant: TOYOTA JIDOSHA KABUSHIKI KAISHA, Toyota-shi (JP)

(72) Inventors: Yuto IKEDA, Okazaki-shi (JP); Satoshi IDO, Toyota-shi (JP); Hibiki UEURA, Toyota-shi (JP)

(21) Appl. No.: 19/424,132

(22) Filed: Dec. 18, 2025

(30) Foreign Application Priority Data
Apr. 17, 2025 (JP) 2025-068187

(51) Int. Cl. F02B 37/24

(52) U.S. Cl. CPC F02B 37/24; F05D 2220/40; F05D 2240/128; F05D 2270/3011

(57) ABSTRACT

A controller controls a vehicle including an engine having an injector that supplies hydrogen used as fuel to a cylinder and a VN turbo that adjusts a boost pressure by changing a VN opening degree that is an opening degree of a nozzle vane. The controller includes processing circuitry that determines a target air-fuel ratio and a target boost pressure based on a required torque. The target air-fuel ratio is a target value of an air-fuel ratio of air-fuel mixture that is to be burned in the cylinder. The target boost pressure is a target value of the boost pressure. The processing circuitry also changes the opening degree based on the target air-fuel ratio and the target boost pressure such that the VN opening degree between adjacent ones of nozzle vanes increases as the target air-fuel ratio decreases.

### CROSS-REFERENCE TO RELATED APPLICATIONS

This application is based upon and claims the benefit of priority from Japanese Patent Application No. 2025-068187, filed on Apr. 17, 2025, the entire contents of which are incorporated herein by reference.

### BACKGROUND

### 1. Field

The present disclosure relates to a vehicle controller and a vehicle control method.

### 2. Description of Related Art

JP2021-099036A discloses an engine device including an engine, a forced-induction device, and a controller. When an upstream purge is performed while the forced-induction device is operating, fuel vapor gas is introduced into the intake system. This lowers the air-fuel ratio, which is the ratio of the mass of air to the mass of fuel. To solve this problem, in the engine device, when an upstream purge is performed while the forced-induction device is operating, the throttle valve is controlled such that its opening degree is greater than when the upstream purge is not performed. This prevents a shortage of the amount of air passing through the throttle valve relative to the amount of air required by the engine.

Hydrogen has a larger amount of heat generated per unit mass than fuels such as gasoline or diesel fuel. Therefore, in a hydrogen engine that uses hydrogen as fuel, variations in the air-fuel ratio cause relatively large changes in exhaust temperature. The temperature of the exhaust gas increases as the air-fuel ratio of air-fuel mixture decreases.

A variable-geometry forced-induction device including a variable nozzle mechanism is known. In the variable-geometry forced-induction device, the boost pressure is adjusted by changing the opening degrees of nozzle vanes. In a hydrogen engine including such a variable-geometry forced-induction device, even when the opening degrees of the nozzle vanes remain unchanged, the boost pressure may excessively increase as the air-fuel ratio decreases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present disclosure provides a vehicle controller that controls a vehicle. The vehicle includes an internal combustion engine including a fuel injection device that supplies hydrogen used as fuel into a cylinder and a variable-geometry forced-induction device that adjusts a boost pressure by changing opening degrees of nozzle vanes. The vehicle controller includes processing circuitry configured to determine a target air-fuel ratio and a target boost pressure based on a required torque. The target air-fuel ratio is a target value of an air-fuel ratio of air-fuel mixture that is to be burned in the cylinder. The target boost pressure is a target value of the boost pressure. The processing circuitry is also configured to change the opening degree based on the target air-fuel ratio and the target boost pressure such that a gap between adjacent ones of the nozzle vanes increases as the target air-fuel ratio decreases.

A second aspect of the present disclosure provides a vehicle control method for controlling a vehicle. The vehicle includes an internal combustion engine including a fuel injection device that supplies hydrogen used as fuel into a cylinder and a variable-geometry forced-induction device that adjusts a boost pressure by changing opening degrees of nozzle vanes. The vehicle control method includes determining a target air-fuel ratio and a target boost pressure based on a required torque. The target air-fuel ratio is a target value of an air-fuel ratio of air-fuel mixture that is to be burned in the cylinder. The target boost pressure is a target value of the boost pressure. The vehicle control method also includes changing the opening degree based on the target air-fuel ratio and the target boost pressure such that a gap between adjacent ones of the nozzle vanes increases as the target air-fuel ratio decreases.

Other features and aspects will be apparent from the following detailed description, the drawings, and the claims.

### BRIEF DESCRIPTION OF THE DRAWINGS

FIG. 1 is a diagram schematically showing the configuration of a vehicle including a controller.

FIG. 2 is a flowchart illustrating a procedure for changing the VN opening degree in the VN turbo, the procedure being executed by the processing circuitry of the controller shown in FIG. 1.

FIG. 3 is a block diagram illustrating the process that acquires the reference VN opening degree with reference to the two-dimensional opening degree map, the process being executed by the processing circuitry of the controller shown in FIG. 1.

FIG. 4 is a graph illustrating the relationship between the λ ratio and the correction coefficient in the λ correction map stored in the storage device shown in FIG. 1.

FIG. 5 is a flowchart illustrating a procedure for changing the VN opening degree in the VN turbo, the procedure being executed by the processing circuitry of the controller according to a second embodiment.

FIG. 6 is a block diagram illustrating the process that acquires the VN opening degree instruction value with reference to the three-dimensional opening degree map, the process being executed by the processing circuitry of the controller of the second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

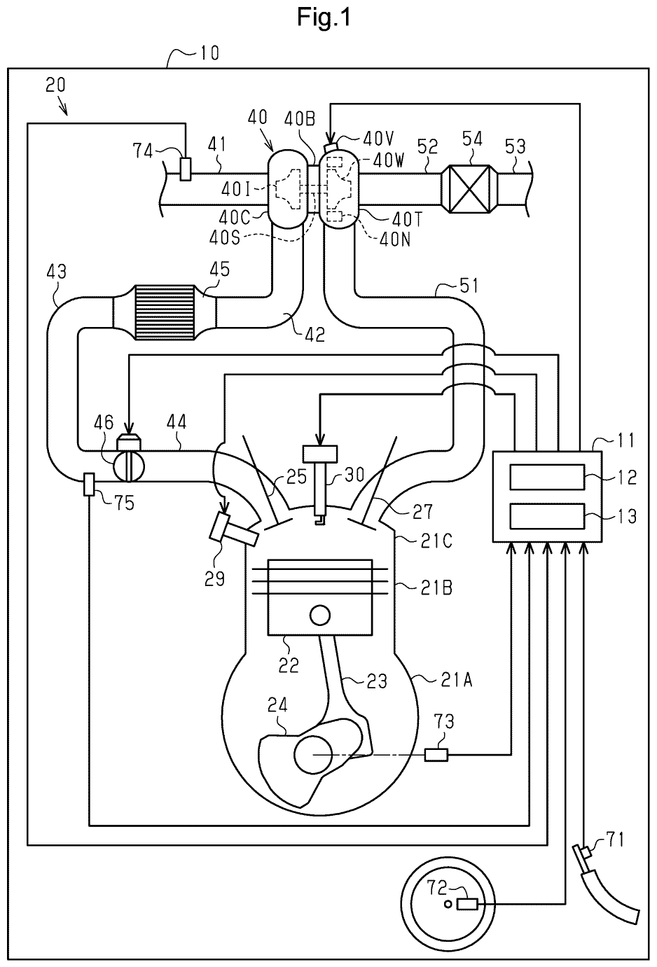

A controller 11 according to a first embodiment, which is a vehicle controller according to an embodiment, will now be described with reference to FIGS. 1 to 4.

### Configuration of Vehicle 10

FIG. 1 is a diagram schematically showing the configuration of a vehicle 10. As shown in FIG. 1, the vehicle 10 includes a controller 11, an engine 20, a variable nozzle (VN) turbo 40, and sensors. The sensors include five sensors: namely, an accelerator opening degree sensor 71, a wheel speed sensor 72, a crank angle sensor 73, an air flow meter 74, and a boost pressure sensor 75.

As shown in FIG. 1, the controller 11 includes processing circuitry 12 and a storage device 13. The processing circuitry 12 is a processing device including a CPU that executes processes in accordance with a program and a ROM that stores the program. The storage device 13 is a non-volatile memory that stores data related to the vehicle 10.

The controller 11 controls the vehicle 10 based on data acquired by the sensors mounted on the vehicle 10. Further, the controller 11 controls devices and components mounted on the vehicle 10, such as the engine 20 and the VN turbo 40, based on that data. Examples of the controller 11 include an engine electronic control unit (ECU).

The engine 20 is an internal combustion engine including cylinders 21B. The fuel of the engine 20 is hydrogen. Each cylinder 21B defines a combustion chamber that burns a mixture of hydrogen and air.

The engine 20 includes a crankcase 21A, the cylinders 21B, a cylinder head 21C, an intake passage, and an exhaust passage. The intake passage includes a first intake passage 41, a second intake passage 42, a third intake passage 43, and a fourth intake passage 44. The exhaust passage includes a first exhaust passage 51, a second exhaust passage 52, and a third exhaust passage 53.

Each cylinder 21B accommodates a piston 22 and a connecting rod 23. The connecting rod 23 is connected to a crankshaft 24 accommodated in the crankcase 21A.

The cylinder head 21C is attached to an upper portion of each cylinder 21B. Each cylinder 21B and the cylinder head 21C define the combustion chamber of the cylinder 21B. The cylinder head 21C includes an intake valve 25, an exhaust valve 27, an injector 29, and an ignition device 30. The engine 20 is a direct-injection hydrogen engine, which directly injects hydrogen into each cylinder 21B. The injector 29 is a fuel injection device, which supplies hydrogen to each cylinder 21B. The fourth intake passage 44 and the first exhaust passage 51, which are connected to the combustion chambers, are connected to the cylinder head 21C.

The intake passage is a passage through which intake air from the outside is introduced into each combustion chamber. The intake air from the outside passes through the first intake passage 41, the second intake passage 42, the third intake passage 43, and the fourth intake passage 44 in this order, and flows into each combustion chamber. An intercooler 45 is arranged between the second intake passage 42 and the third intake passage 43. A throttle valve 46 is arranged between the third intake passage 43 and the fourth intake passage 44. The throttle valve 46 varies its opening degree to change the air flow passage area, thereby adjusting the flow rate of intake air flowing into each cylinder 21B. The downstream end of the fourth intake passage 44 is connected to each combustion chamber. The end is provided with the intake valve 25.

The exhaust passage is a passage through which exhaust gas from each cylinder 21B is introduced into an exhaust system component. The exhaust gas from each cylinder 21B passes through the first exhaust passage 51, the second exhaust passage 52, and the third exhaust passage 53 in this order, and flows out. The upstream end of the first exhaust passage 51 is connected to each combustion chamber. The end is provided with the exhaust valve 27. A catalyst device 54, which removes harmful substances from exhaust gas, is arranged between the second exhaust passage 52 and the third exhaust passage 53.

The VN turbo 40 is installed in the intake passage and the exhaust passage of the engine 20. The VN turbo 40 is a forced-induction device including a compressor 40C and a turbine 40T. The compressor 40C and the turbine 40T are connected to each other via a bearing portion 40B. A turbine shaft 40S is inserted through the bearing portion 40B. A turbine wheel 40W, which is accommodated in the turbine 40T, and a compressor impeller 40I, which is accommodated in the compressor 40C, are fixed to the turbine shaft 40S. The compressor 40C is connected to the first intake passage 41 and the second intake passage 42. The turbine 40T is connected to the first exhaust passage 51 and the second exhaust passage 52.

In the VN turbo 40, when the exhaust gas that has flowed from the first exhaust passage 51 into the turbine 40T rotates the turbine wheel 40W, the turbine shaft 40S and the compressor impeller 40I rotate integrally with the turbine wheel 40W. The rotation of the compressor impeller 40I causes the intake air that has flowed from the first intake passage 41 into the compressor 40C to be compressed and delivered to the second intake passage 42.

The VN turbo 40 is a variable-geometry forced-induction device. The VN turbo 40 includes nozzle vanes 40N and a variable nozzle mechanism 40V. The nozzle vanes 40N are located around the turbine wheel 40W inside the turbine 40T. The nozzle vanes 40N are partition plates that guide, to the turbine wheel 40W, the exhaust gas that has flowed from the first exhaust passage 51 into the turbine 40T. The nozzle vanes 40N are arranged along the outer circumference of the turbine wheel 40W, with their surfaces oriented in the circumferential direction of the turbine wheel 40W. The exhaust gas that has flowed into the turbine 40T passes through a gap between adjacent ones of the nozzle vanes 40N and flows into the turbine wheel 40W.

The variable nozzle mechanism 40V, which is arranged on the turbine 40T, changes the angle of each nozzle vane 40N by means of a link mechanism. The link mechanism is driven by an actuator installed in the variable nozzle mechanism 40V. When the angle of the nozzle vane 40N changes, the size of the gap between adjacent ones of the nozzle vanes 40N changes. The angle of the nozzle vane 40N is referred to as an opening degree of the nozzle vane 40N. Hereinafter, the opening degree of the nozzle vane 40N is referred to as a VN opening degree OP.

When each nozzle vane 40N is angled so that the gap between adjacent ones of the nozzle vanes 40N decreases, the value of the VN opening degree OP increases. When each nozzle vane 40N is angled so that the gap between adjacent ones of the nozzle vanes 40N increases, the value of the VN opening degree OP decreases. When the gap between adjacent ones of the nozzle vanes 40N decreases, the flow velocity of the exhaust gas flowing through the gap to the turbine wheel 40W increases. Accordingly, the rotational speed of the turbine wheel 40W increases. Therefore, when the energy of the exhaust gas flowing into the turbine 40T remains unchanged, the boost pressure in the engine 20 increases as the VN opening degree OP increases. When the gap between the nozzle vanes 40N increases, the flow velocity of the exhaust gas passing through the gap to the turbine wheel 40W decreases. Therefore, when the energy of the exhaust gas flowing into the turbine 40T remains unchanged, the boost pressure in the engine 20 decreases as the VN opening degree OP decreases. In this manner, the VN turbo 40 changes the VN opening degree OP to adjust the boost pressure in the engine 20. In this specification, the VN opening degree is defined such that it increases when the flow rate is increased, that is, when the gap between adjacent ones of the nozzle vanes 40N is narrowed to increase flow velocity.

The controller 11 controls the engine 20 and the VN turbo 40 based on the data acquired by the sensors mounted on the vehicle 10. For example, the accelerator opening degree sensor 71 detects an accelerator operation by the driver. The accelerator opening degree sensor 71 detects the amount by which the driver operates the accelerator, and sends it to the controller 11 as an accelerator opening degree. The wheel speed sensor 72 measures the wheel speed of each wheel of the vehicle 10, and sends it to the controller 11. The controller 11 calculates the vehicle speed of the vehicle 10 based on the wheel speed.

The crank angle sensor 73 measures the amount of change in crank angle per unit time, and sends it to the controller 11. The controller 11 calculates the engine rotation speed of the engine 20 based on the amount of change in crank angle per unit time. The air flow meter 74 measures the flow rate of air flowing through the first intake passage 41, and sends it to the controller 11. The flow rate of intake air in the engine 20 is the flow rate of air measured by the air flow meter 74. The boost pressure sensor 75 measures the pressure of intake air in the third intake passage 43, and sends it to the controller 11. The pressure of the intake air measured by the boost pressure sensor 75 is the boost pressure in the engine 20.

The controller 11 is connected to each of the injector 29, the ignition device 30, the throttle valve 46, and the variable nozzle mechanism 40V. The controller 11 controls the injector 29 to adjust the amount of hydrogen injected into the cylinders 21B. The controller 11 controls the ignition device 30 to change the ignition timing of the cylinders 21B. The controller 11 controls the throttle valve 46 to adjust the amount of air introduced into the cylinders 21B. The controller 11 controls the variable nozzle mechanism 40V to change the VN opening degree OP.

### Change to VN Opening Degree OP

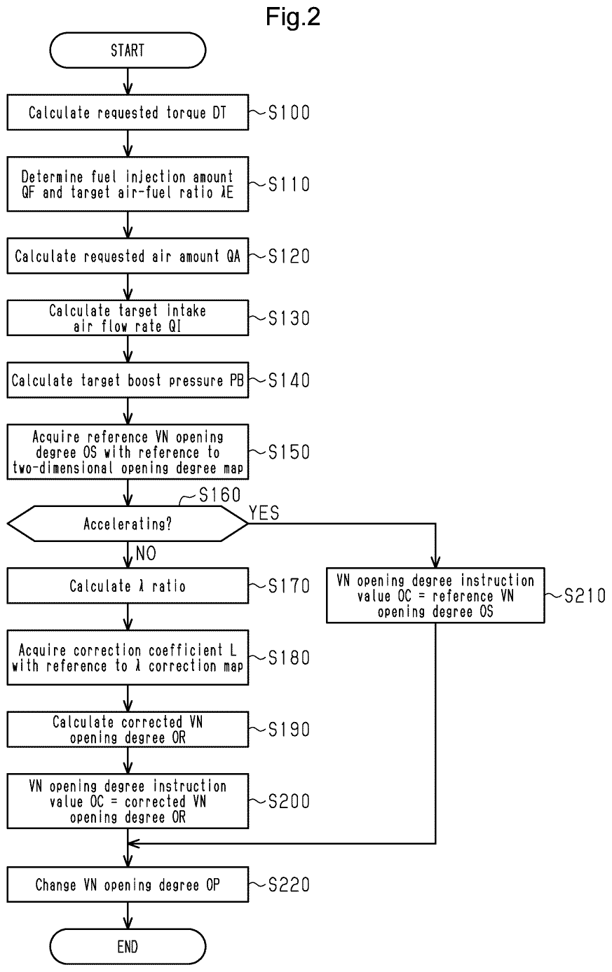

FIG. 2 illustrates processes executed by the processing circuitry 12 of the controller 11 to change the VN opening degree OP. The processing circuitry 12 repeatedly executes a series of processes shown in FIG. 2, for example, at a cycle shorter than the interval of fuel injection in each cylinder 21B. The letter S shown in FIG. 2 is an abbreviation indicating a step in the series of processes.

First, in S100, the processing circuitry 12 calculates a required torque DT. The required torque DT is determined based on parameters such as an accelerator opening degree, a vehicle speed, an engine rotation speed, and a gear ratio. The magnitude of the required torque DT varies depending on, for example, the accelerator operation by the driver and the traveling state of the vehicle 10.

In S110, the processing circuitry 12 determines a fuel injection amount QF and a target air-fuel ratio λE based on the required torque DT calculated in S100. The fuel injection amount QF is the amount of hydrogen fuel injected into the cylinder 21B from the injector 29. The target air-fuel ratio λE is a target value of an air-fuel ratio λ of the air-fuel mixture to be burned in the cylinder 21B. When hydrogen is used as fuel, the air-fuel ratio λ is the ratio of the mass of air to the mass of hydrogen in the air-fuel mixture. Thus, as the air-fuel ratio λ decreases, the ratio of the hydrogen fuel in the air-fuel mixture increases. The processing circuitry 12 calculates the fuel injection amount QF and target air-fuel ratio λE that are necessary for satisfying the required torque DT. In general, the processing circuitry 12 increases the fuel injection amount QF as the required torque DT increases. For example, the processing circuitry 12 decreases the target air-fuel ratio λE as the required torque DT increases.

In S120, the processing circuitry 12 calculates the required air amount QA based on the fuel injection amount QF and the target air-fuel ratio λE. The required air amount QA is the product of the amount of hydrogen fuel corresponding to the fuel injection amount QF and the target air-fuel ratio λE that were determined in S110, and is the amount of air necessary for combustion in the cylinder 21B.

In S130, the processing circuitry 12 calculates a target intake air flow rate QI based on the required air amount QA. The target intake air flow rate QI is a target value of the flow rate of the intake air introduced into the VN turbo 40. Specifically, the target intake air flow rate QI is the flow rate of intake air necessary for introducing the air corresponding to the required air amount QA into the cylinder 21B.

In S140, the processing circuitry 12 calculates a target boost pressure PB. The target boost pressure PB is a target value of the boost pressure. Specifically, the target boost pressure PB is necessary for introducing the air corresponding to the required air amount QA into the cylinder 21B by performing forced induction with the intake air introduced at the target intake air flow rate QI.

As described above, in S110 to S140, the processing circuitry 12 determines the target air-fuel ratio λE, the target intake air flow rate QI, and the target boost pressure PB based on the required torque DT.

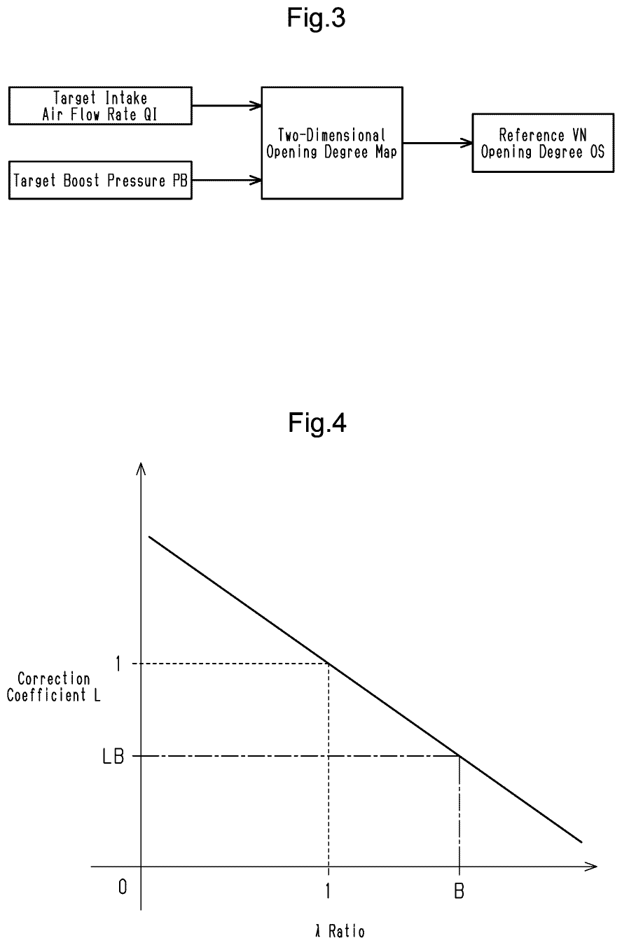

In S150, the processing circuitry 12 acquires a reference VN opening degree OS with reference to a two-dimensional opening degree map. FIG. 3 is a block diagram of the process executed by the processing circuitry 12 to acquire the reference VN opening degree OS with reference to the two-dimensional opening degree map. The two-dimensional opening degree map is stored in the storage device 13 of the controller 11. The two-dimensional opening degree map may be stored in the ROM of the processing circuitry 12.

The VN turbo 40 changes boost pressure by changing the VN opening degree OP. The VN turbo 40 achieves the target boost pressure PB by changing the VN opening degree OP to an optimal opening degree relative to the target intake air flow rate QI. The two-dimensional opening degree map is a two-dimensional map in which an optimal value of the VN opening degree OP for achieving the target boost pressure PB at the target intake air flow rate QI is determined for each combination of the values of the target intake air flow rate QI and the target boost pressure PB. The two-dimensional opening degree map is created, with the air-fuel ratio λ fixed at a reference air-fuel ratio λS. The reference air-fuel ratio λS is determined as a reference in the engine 20. For example, the reference air-fuel ratio λS is set to a maximum value that is included in values at which the target air-fuel ratio λE is settable in the engine 20. Under the condition that the air-fuel ratio λ is the reference air-fuel ratio λS, the value of an optimal VN opening degree OP for achieving the target boost pressure PB relative to the target intake air flow rate QI is the reference VN opening degree OS (i.e., reference opening degree).

As shown in FIG. 3, the processing circuitry 12 refers to the two-dimensional opening degree map to acquire the reference VN opening degree OS corresponding to the combination of the target intake air flow rate QI calculated in S130 and the target boost pressure PB calculated in S140.

In the S160, the processing circuitry 12 determines whether the vehicle 10 is accelerating. When determining that the vehicle 10 is not accelerating (S160: NO), the processing circuitry 12 advances the process to S170. When determining that the vehicle 10 is accelerating (S160: YES), the processing circuitry 12 advances the process to S210. For example, when the accelerator opening degree is greater than or equal to a predetermined value, the processing circuitry 12 determines that the vehicle 10 is accelerating.

In the S170, the processing circuitry 12 calculates a λ ratio. The λ ratio is the ratio of the reference air-fuel ratio λS to the target air-fuel ratio λE, and is calculated according to the following Equation 1.

$$λ ratio = \frac{λ S}{λ E} \qquad Equation 1$$

As shown in Equation 1, the λ ratio increases as the value of the target air-fuel ratio λE decreases. After calculating the λ ratio in accordance with Equation 1, the processing circuitry 12 advances the process to S180.

In S180, the processing circuitry 12 acquires a correction coefficient L with reference to a λ correction map. FIG. 4 is a graph illustrating the relationship between the λ ratio and the correction coefficient L in the λ correction map. The λ correction map is stored in the storage device 13. The λ correction map may be stored in the ROM of the processing circuitry 12. As shown in FIG. 4, in the λ correction map, the value of the correction coefficient L is set to be smaller as the value of the λ ratio increases. The correction coefficient L is set such that its value is 1 when the value of the λ ratio is 1.

The processing circuitry 12 acquires the correction coefficient L corresponding to the λ ratio calculated in the S170 with reference to the λ correction map. For example, when the value of the λ ratio is B, the processing circuitry 12 acquires LB as the value of the correction coefficient L with reference to the λ correction map.

In S190, the processing circuitry 12 corrects the reference VN opening degree OS using the value of the correction coefficient L acquired in S180. The processing circuitry 12 corrects the reference VN opening degree OS in accordance with the following Equation 2, thereby acquiring a corrected VN opening degree OR.

OR=L×OS Equation 2

The value of the corrected VN opening degree OR calculated in accordance with Equation 2 decreases as the value of the correction coefficient L decreases. Accordingly, the value of the corrected VN opening degree OR decreases as the target air-fuel ratio λE decreases. That is, the processing circuitry 12 corrects the reference VN opening degree OS such that the value of the VN opening degree OP decreases as the target air-fuel ratio λE decreases.

In S200, the processing circuitry 12 substitutes the corrected VN opening degree OR into a VN opening degree instruction value OC. The VN opening degree instruction value OC is a value included in a signal transmitted from the processing circuitry 12 to the variable nozzle mechanism 40V. The VN opening degree instruction value OC is used to instruct the variable nozzle mechanism 40V to change the opening degree to which it should be changed.

When determining that the vehicle 10 is accelerating in S160, the processing circuitry 12 substitutes the reference VN opening degree OS into the VN opening degree instruction value OC in S210. That is, when determining that the vehicle 10 is accelerating, the processing circuitry 12 does not perform the correction using the correction coefficient L illustrated in S170, S180, and S190.

In the S220, the processing circuitry 12 transmits a control signal including the VN opening degree instruction value OC to the variable nozzle mechanism 40V to change the VN opening degree OP to the VN opening degree instruction value OC. In this manner, the processing circuitry 12 changes the VN opening degree OP to the VN opening degree OP determined based on the required torque DT. Upon executing the process of S220, the processing circuitry 12 ends the series of processes.

### Operation of the First Embodiment

In a case where the VN opening degree OP remains unchanged, as the air-fuel ratio λ of air-fuel mixture decreases, the exhaust energy increases with an increase in fuel components. This increases the driving force of the forced-induction device, thereby increasing the boost pressure. When the target air-fuel ratio λE is relatively small, the controller 11 changes the VN opening degree OP so as to increase the gap between adjacent ones of the nozzle vanes 40N of the VN turbo 40. The controller 11 changes the VN opening degree OP in accordance with a change in the target air-fuel ratio λE, thereby preventing an increase in the boost pressure that would occur due to a reduction in the air-fuel ratio λ.

### Advantages of the First Embodiment

(1-1) The controller 11 prevents the boost pressure from being significantly greater than a target boost pressure when the air-fuel ratio λ decreases.

(1-2) The processing circuitry 12 determines the target intake air flow rate QI, which is a target value of the flow rate of intake air introduced into the VN turbo 40, based on the required torque DT. The processing circuitry 12 refers to the two-dimensional opening degree map. In this map, the reference VN opening degree OS corresponding to a combination of the target boost pressure PB and the target intake air flow rate QI when the air-fuel ratio λ is the reference air-fuel ratio λS is determined in advance. The processing circuitry 12 acquires the reference VN opening degree OS corresponding to the target boost pressure PB and the target intake air flow rate QI with reference to the two-dimensional opening degree map. The processing circuitry 12 corrects the reference VN opening degree OS using the correction coefficient L, which is determined based on the λ ratio, such that the gap between adjacent ones of the nozzle vanes 40N increases as the λ ratio increases. Then, the processing circuitry 12 changes the VN opening degree OP to the corrected VN opening degree OR, which is a corrected opening degree.

For the two-dimensional opening degree map, the reference VN opening degree OS corresponding to two parameters, namely, the target boost pressure PB and the target intake air flow rate QI, is preset. The reference VN opening degree OS is set such that the VN opening degree OP becomes a proper opening degree relative to the target boost pressure PB and the target intake air flow rate QI when the air-fuel ratio λ is the reference air-fuel ratio λS.

The controller 11 acquires the reference VN opening degree OS, which is the VN opening degree OP that is suitable for the case where the air-fuel ratio λ is the reference air-fuel ratio λS, with reference to the two-dimensional opening degree map. The controller 11 corrects the reference VN opening degree OS using the correction coefficient L. When the target air-fuel ratio λE is smaller than the reference air-fuel ratio λS, the controller 11 corrects the VN opening degree OP to prevent an increase in the boost pressure. Thus, the controller 11 executes a simple correction process using the λ ratio, which is between two air-fuel ratios λ, so that the VN opening degree OP suitable for the target air-fuel ratio λE is achieved.

(1-3) The reference air-fuel ratio λS is a maximum value, which is included in the values at which the target air-fuel ratio XE is settable in the engine 20. When the vehicle 10 is accelerating, the processing circuitry 12 does not correct the reference VN opening degree OS using the correction coefficient L. Instead, the processing circuitry 12 changes the VN opening degree OP to the reference VN opening degree OS corresponding to the target boost pressure PB and the target intake air flow rate QI.

When the reference air-fuel ratio λS is the maximum value included in the values at which the target air-fuel ratio λE is settable, the reference air-fuel ratio λS is the largest one of the air-fuel ratios λ of the air-fuel mixture to be burned by combustion in the engine 20. Thus, when the VN opening degree OP is changed to the reference VN opening degree OS, the boost pressure is more likely to increase than when the VN opening degree OP is changed in accordance with the target boost pressure PB.

When the vehicle 10 is accelerating, there is a delay in the increase of the boost pressure. This causes the intake air to be insufficient relative to the hydrogen injected into the cylinder 21B. As a result, the target air-fuel ratio λE decreases. When the gap between adjacent ones of the nozzle vanes 40N is increased in correspondence with a decrease in the air-fuel ratio λ, an increase in the boost pressure is prevented. This causes further insufficient intake air.

During acceleration of the vehicle 10, the controller 11 fixes the VN opening degree OP at the reference VN opening degree OS without performing correction corresponding to the target air-fuel ratio λE, thereby facilitating an increase in the boost pressure. Thus, the controller 11 prompts an increase in the boost pressure during acceleration to allow the engine 20 to produce output more readily.

### Second Embodiment

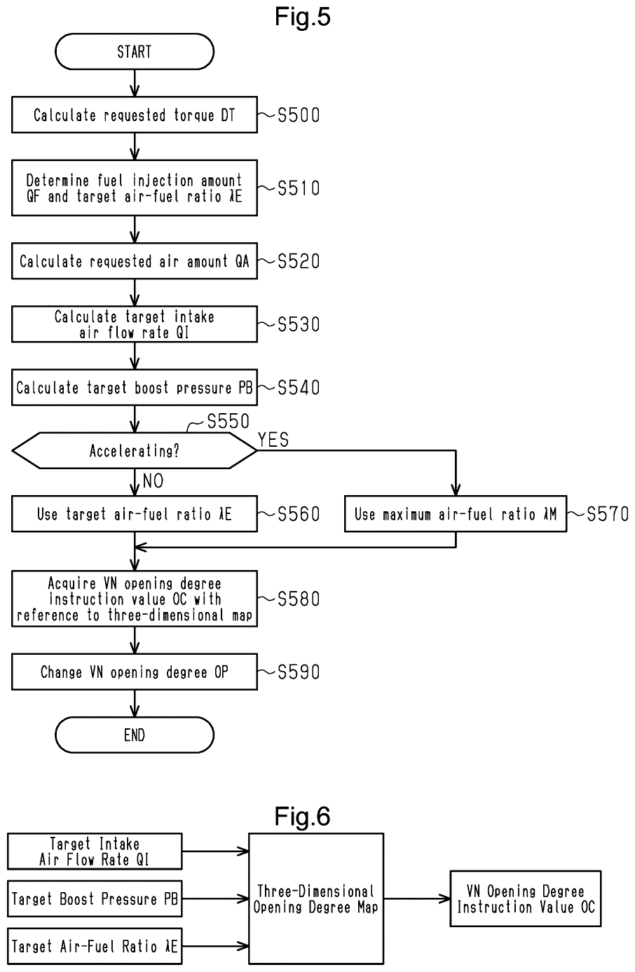

A second embodiment of the controller 11 will now be described with reference to FIGS. 5 and 6. In the following description, parts that mainly differ from those of the first embodiment will be described. Parts identical to those in the first embodiment will not be described in detail. The second embodiment is different from the first embodiment in that the processing circuitry 12 acquires the VN opening degree instruction value OC with reference to a three-dimensional opening degree map. The storage device 13 stores the three-dimensional opening degree map, instead of the two-dimensional opening degree map and the λ correction map.

FIG. 5 illustrates processes executed by the processing circuitry 12 of the second embodiment to change the VN opening degree OP. In the same manner as the first embodiment, the processing circuitry 12 repeatedly executes a series of processes shown in FIG. 5, for example, at a cycle shorter than the interval of fuel injection in each cylinder 21B. The letter S shown in FIG. 5 is an abbreviation indicating a step in the series of processes.

In S500, the processing circuitry 12 calculates the required torque DT. In S510, the processing circuitry 12 determines the fuel injection amount QF and the target air-fuel ratio λE. In S520, the processing circuitry 12 calculates the required air amount QA. In S530, the processing circuitry 12 calculates the target intake air flow rate QI. In S540, the processing circuitry 12 calculates the target boost pressure PB. In S500 to S540, the processes executed by the processing circuitry 12 are the same as those in S100 to S140 of FIG. 2.

In the S550, the processing circuitry 12 determines whether the vehicle 10 is accelerating, in the same manner as the first embodiment. When determining that the vehicle 10 is not accelerating (S550: NO), the processing circuitry 12 advances the process to S560. When determining that the vehicle 10 is accelerating (S550: YES), the processing circuitry 12 advances the process to S570.

In S560, the processing circuitry 12 determines to use, as the target air-fuel ratio λE, the target air-fuel ratio λE determined in S510 in the processes from S580 onward.

In S570, the processing circuitry 12 determines to use a maximum air-fuel ratio λM as the target air-fuel ratio λE in the processes from S580 onward. The maximum air-fuel ratio λM is a maximum value of the target air-fuel ratio λE that is settable in the engine 20.

In S580, the processing circuitry 12 acquires the VN opening degree instruction value OC with reference to a three-dimensional opening degree map. In the same manner as the first embodiment, the VN opening degree instruction value OC is a value included in a signal transmitted from the processing circuitry 12 to the variable nozzle mechanism 40V. The VN opening degree instruction value OC is used to instruct the variable nozzle mechanism 40V to change the opening degree to which it should be changed.

FIG. 6 is a block diagram of the process executed by the processing circuitry 12 to acquire the VN opening degree instruction value OC with reference to the three-dimensional opening degree map. The three-dimensional opening degree map is stored in the storage device 13 of the controller 11. The three-dimensional opening degree map may be stored in the ROM of the processing circuitry 12. The three-dimensional opening degree map is a three-dimensional map in which an optimal value of the VN opening degree OP for achieving the target boost pressure PB at the target air-fuel ratio λE and the target intake air flow rate QI is determined for each combination of the values of the target intake air flow rate QI, the target boost pressure PB, and the target air-fuel ratio E.

As shown in FIG. 6, the processing circuitry 12 acquires the VN opening degree instruction value OC as the VN opening degree OP corresponding to the target intake air flow rate QI, the target boost pressure PB, and the target air-fuel ratio λE with reference to the three-dimensional opening degree map. Specifically, the processing circuitry 12 acquires the VN opening degree instruction value OC corresponding to a combination of the target air-fuel ratio λE determined in S510, the target intake air flow rate QI determined in S530, and the target boost pressure PB determined in S540, with reference to the three-dimensional opening degree map. When determining that the vehicle 10 is accelerating in S550, the processing circuitry 12 performs the process of S580 using the maximum air-fuel ratio λM as the target air-fuel ratio λE.

In the S590, the processing circuitry 12 transmits a control signal including the VN opening degree instruction value OC to the variable nozzle mechanism 40V to change the VN opening degree OP to the VN opening degree instruction value OC. In this manner, the processing circuitry 12 changes the VN opening degree OP to the VN opening degree OP determined based on the required torque DT. Upon executing the process of S590, the processing circuitry 12 ends the series of processes.

### Operation of the Second Embodiment

For the three-dimensional opening degree map, the VN opening degree instruction value OC corresponding to three parameters, namely, the target air-fuel ratio λE, the target boost pressure PB, and the target intake air flow rate QI, is preset. The VN opening degree instruction value OC is set such that the VN opening degree OP becomes a proper opening degree relative to the target air-fuel ratio λE, the target boost pressure PB, and the target intake air flow rate QI. The controller 11 acquires the VN opening degree instruction value OC suitable for each of the target air-fuel ratio λE, the target boost pressure PB, and the target intake air flow rate QI with reference to the three-dimensional opening degree map. The VN opening degree instruction value OC is also optimized for the target air-fuel ratio λE.

### Advantages of the Second Embodiment

The second embodiment provides the following advantages in addition to advantage (1-1) of the first embodiment.

(2-1) The processing circuitry 12 determines the target intake air flow rate QI, which is a target value of the flow rate of intake air introduced into the VN turbo 40, based on the required torque DT. The processing circuitry 12 acquires the VN opening degree instruction value OC corresponding to the target air-fuel ratio λE, the target boost pressure PB, and the target intake air flow rate QI with reference to the three-dimensional opening degree map. In this map, the VN opening degree OP corresponding to a combination of the target air-fuel ratio λE, the target boost pressure PB, and the target intake air flow rate QI is preset. The processing circuitry 12 changes the VN opening degree OP to the acquired VN opening degree instruction value OC. Thus, the controller 11 achieves the VN opening degree OP suitable for the target air-fuel ratio λE with reference to the three-dimensional opening degree map.

(2-2) When the vehicle 10 is accelerating, the processing circuitry 12 uses the maximum air-fuel ratio λM, which is the maximum value included in the values at which the target air-fuel ratio λE is settable in the engine 20, as the value of the target air-fuel ratio λE when referring to the three-dimensional opening degree map. The processing circuitry 12 acquires the VN opening degree instruction value OC corresponding to the maximum air-fuel ratio λM, the target boost pressure PB, and the target intake air flow rate QI with reference to the three-dimensional opening degree map. Then, the processing circuitry 12 changes the VN opening degree OP to the acquired VN opening degree instruction value OC.

The maximum air-fuel ratio λM is the largest one of the air-fuel ratios λ of the air-fuel mixture to be burned by combustion in the engine 20. Accordingly, when the VN opening degree OP is changed with reference to the three-dimensional opening degree map using the maximum air-fuel ratio λM as the target air-fuel ratio λE, the boost pressure is more likely to increase than when the VN opening degree OP is changed in accordance with the target air-fuel ratio λE determined based on the required torque DT.

When the vehicle 10 is accelerating, there is a delay in the increase of the boost pressure. This causes the intake air to be insufficient relative to the hydrogen injected into the cylinder 21B. As a result, the target air-fuel ratio λE decreases. When the gap between adjacent ones of the nozzle vanes 40N is increased in correspondence with a decrease in the air-fuel ratio λ, an increase in the boost pressure is prevented. This causes further insufficient intake air.

During acceleration of the vehicle 10, the controller 11 fixes the VN opening degree OP at the VN opening degree OP obtained when the target air-fuel ratio λE is the maximum air-fuel ratio λM, thereby facilitating an increase in the boost pressure. Thus, the controller 11 prompts an increase in the boost pressure during acceleration to allow the engine 20 to produce output more readily.

### Modifications

The following are elements that can be modified and are generally applicable to each of the above-described embodiments. The following modifications can be combined as long as the combined modifications remain technically consistent with each other.

In S160 and S550, the processing circuitry 12 may determine whether forced induction is being performed on the engine 20, instead of determining whether the vehicle 10 is accelerating. For example, when determining that forced induction is being performed on the engine 20 in S160, the processing circuitry 12 may advance the process to S170. When determining that forced induction is not being performed on the engine 20 in S160, the processing circuitry 12 may advance the process to S210. With this configuration, when the engine 20 is operating in a naturally-aspirated state in which forced induction is not being performed on the engine 20, the correction using the correction coefficient L will not be performed. This allows the controller 11 of the modification to simplify the process that changes the VN opening degree OP when forced induction is not being performed on the engine 20.

The processing circuitry 12 may change the VN opening degree OP based on the target air-fuel ratio λE and the target boost pressure PB. For example, the processing circuitry 12 may change the VN opening degree OP with reference to a two-dimensional map in which an optimal value of the VN opening degree OP for achieving the target boost pressure PB at the target air-fuel ratio λE in each combination of the values of the target air-fuel ratio λE and the target boost pressure PB. In this two-dimensional map, the value of the VN opening degree OP is determined according to a relationship in which the VN opening degree OP decreases as the target air-fuel ratio λE decreases.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A vehicle controller that controls a vehicle, wherein the vehicle includes an internal combustion engine including a fuel injection device that supplies hydrogen used as fuel into a cylinder and a variable-geometry forced-induction device that adjusts a boost pressure by changing opening degrees of nozzle vanes, the vehicle controller comprising processing circuitry configured to:
determine a target air-fuel ratio and a target boost pressure based on a required torque, the target air-fuel ratio being a target value of an air-fuel ratio of air-fuel mixture that is to be burned in the cylinder, and the target boost pressure being a target value of the boost pressure; and
change the opening degree based on the target air-fuel ratio and the target boost pressure such that a gap between adjacent ones of the nozzle vanes increases as the target air-fuel ratio decreases.

2. The vehicle controller according to claim 1, wherein
the processing circuitry is configured to:
determine a target intake air flow rate based on the required torque, the target intake air flow rate being a target value of a flow rate of intake air that is to be introduced into the forced-induction device;
acquire the reference opening degree corresponding to the target boost pressure and the target intake air flow rate with reference to a two-dimensional map in which a reference opening degree is preset when the air-fuel ratio is a reference air-fuel ratio, the reference opening degree being the opening degree corresponding to a combination of the target boost pressure and the target intake air flow rate, and the reference air-fuel ratio being set as a reference in the internal combustion engine;
correct the reference opening degree using a correction coefficient such that the gap between the adjacent ones of the nozzle vanes increases as a ratio of the reference air-fuel ratio to the target air-fuel ratio increases, the correction coefficient being set based on the ratio; and
change the opening degree to the corrected opening degree.

3. The vehicle controller according to claim 2, wherein
the reference air-fuel ratio is a maximum value, the maximum value being included in values at which the target air-fuel ratio is settable in the internal combustion engine, and
the processing circuitry is configured to change, when the vehicle is accelerating, the opening degree to the reference opening degree corresponding to the target boost pressure and the target intake air flow rate without correcting the reference opening degree using the correction coefficient.

4. The vehicle controller according to claim 1, wherein
the processing circuitry is configured to:
determine a target intake air flow rate based on the required torque, the target intake air flow rate being a target value of a flow rate of intake air that is to be introduced into the forced-induction device;
acquire the opening degree corresponding to the target air-fuel ratio, the target boost pressure, and the target intake air flow rate with reference to a three-dimensional map in which the opening degree corresponding to a combination of the target air-fuel ratio, the target boost pressure, and the target intake air flow rate is preset; and
change the opening degree to the acquired opening degree.

5. The vehicle controller according to claim 4, wherein
when the vehicle is accelerating, the processing circuitry uses a maximum value as a value of the target air-fuel ratio to refer to the three-dimensional map, the maximum value being included in values at which the target air-fuel ratio is settable in the internal combustion engine, and
the processing circuitry is configured to:
acquire the opening degree corresponding to the maximum value at the target air-fuel ratio, the target boost pressure, and the target intake air flow rate with reference to the three-dimensional map; and
change the opening degree to the acquired opening degree.

6. A vehicle control method for controlling a vehicle, wherein the vehicle includes an internal combustion engine including a fuel injection device that supplies hydrogen used as fuel into a cylinder and a variable-geometry forced-induction device that adjusts a boost pressure by changing opening degrees of nozzle vanes, the vehicle control method comprising:
determining a target air-fuel ratio and a target boost pressure based on a required torque, the target air-fuel ratio being a target value of an air-fuel ratio of air-fuel mixture that is to be burned in the cylinder, and the target boost pressure being a target value of the boost pressure; and
changing the opening degree based on the target air-fuel ratio and the target boost pressure such that a gap between adjacent ones of the nozzle vanes increases as the target air-fuel ratio decreases.
